(19) United States
(12) Patent Application Publication
(10) Pub. No.: US 2014/0246386 A1
(43) Pub. Date: Sep. 4, 2014

(54) METHOD FOR THERMAL SEPARATION OF A VOLATILE SUBSTANCE FROM A NON- OR LESS VOLATILE SUBSTRATE

(71) Applicant: LIST HOLDING AG, Arisdorf (CH)

(72) Inventors: Daniel WITTE, Grenzach-Wyhlen (DE); Andreas DIENER, Miltitz (DE); Pierre LIECHTI, Muttenz (CH)

(73) Assignee: List Holding AG, Arisdorf (CH)

(21) Appl. No.: 14/349,795

(22) PCT Filed: Oct. 5, 2012
(86) PCT No.: PCT/EP2012/069784

§ 371 Date: Apr. 4, 2014

(30) Foreign Application Priority Data
Oct. 5, 2011 (DE) 10 2011 054 180.2

(51) Int. Cl. B01D 1/00; B01D 19/00

(52) U.S. Cl. CPC B01D 1/00; B01D 19/0042
USPC 210/774

(57) ABSTRACT

In a method for the thermal separation of a volatile substance from a non- or less volatile substrate having a phase boundary towards a gas chamber that receives the volatile substance subsequent to vaporisation and/or sublimation, mechanical energy is supplied to the phase boundary between the substrate and the gas chamber to increase the material exchange of the volatile substance. In the method, the material exchange is increased by the addition of an additive or mechanical energy to the surface of the phase transition in such manner that said supplied mechanical energy destroys bubbles containing the volatile substrate, so that the volatile substrate can escape to the gas chamber.

### BACKGROUND OF THE INVENTION

The invention relates to a method for thermal separation of a volatile substance from a non- or less volatile substrate with a phase boundary in relation to a gas space that receives the volatile substance after vaporization and/or sublimation.

The thermal separation of volatile substances from nonvolatile substrates in liquids or pastes is a widely used chemical engineering process. It involves subjecting the substrate to be treated to such thermodynamic conditions that the vapor pressure of the volatile substances lies above the partial pressure of this volatile substance in a surrounding gas phase that encloses the substrate to be treated. Since, by definition, no thermal separation takes place in the starting substrate, the substrate is to be treated by heating or lowering the partial pressure of the volatile substance by gassifying a third substance or lowering the pressure.

It is known in chemical engineering that the process described above is limited either by the heat transfer or the mass transfer or a combination of the two. The heat transfer may be a limitation because the vaporization of the volatile substance is an endothermic process. In order to maintain a vaporization at a constant partial pressure, energy must therefore be externally supplied to the substrate. The process is determined by the heat transfer whenever the mass transfer is very rapid and it can be assumed that the substance is increasingly very close to the point of equilibrium between the gas phase and the boiling mixture. For the present invention, this possibility of limitation is not considered, but rather the possibility of limitation due to the mass transfer.

The present invention addresses the problem of increasing the mass transfer, and in particular increasing and accelerating the extraction of the volatile substance from the substrate.

### SUMMARY OF THE INVENTION

The problem is solved by supplying mechanical energy to the phase boundary from the substrate to the gas space in order to increase the mass transfer of the volatile substance.

### DETAILED DESCRIPTION

It has been observed that, particularly in process spaces that have good mixing throughout, the limitation of the mass transfer is usually of a convective nature. The volatile substance already vaporizes in the mass of the substrate, but must still be transported to the surfaces. If the substance is of low viscosity, the uplift by bubbles may be sufficient to transport enough bubbles to the phase boundary in relation to the gas space. If, however, the substance is a paste or is viscous, the substance must be mixed. The transfer rate of bubbles can in this case be described well by the penetration theory, which establishes a relationship between the available surface area in relation to the gas space and the number of mixing events.

More recent studies have shown, however, that not only the transfer of the bubbles produced has a limiting effect on the process but also their rate of destruction at the surface of the substrate in relation to the gas space. Only if the bubbles burst at the surface do they transfer their contents to the gas space, otherwise they are mixed again into the substrate. In the case of a low-viscosity substrate, such behavior is evident as frothing. However, it has been possible to show by a simulation calculation that the rate of destruction is decisive for the mass transfer also in the case of high-viscosity pastes.

In order to increase the rate of destruction of the bubbles at the surface of the substrate, according to the invention this surface is acted upon in such a way that these bubbles are effectively destroyed. According to the invention, this is achieved for example by metering in a partly volatile additive. This volatile additive may be the same as that which is already present in the substrate and is intended to be separated, or be different, whereby an additional stripping effect is achieved. According to the invention, the metering in of the additive must take place as uniformly as possible on the phase boundary for the mass transfer of the substrate. It has been found by simulation calculation that with this measure the mass transfer is increased by a factor of 100.

The method of metering in a volatile additive presumably leads to a cavitation effect by vaporization or sublimation thereof, which then provides the energy for destroying the bubbles.

According to the invention, it is advantageous for example to meter the volatile substance in from above onto a rotating shaft on which the substrate is located, the shaft being located in a process space in which the thermal separation takes place. In this case, it must be ensured according to the invention that a free phase boundary onto which the additive can be metered is always available, i.e. the process space must not be completely filled with substrate. According to the invention, that is brought about for example by using a kneader shaft. The additive is distributed well over the substrate in the circumferential direction by the turning of the shaft.

If the shaft is formed as a hollow shaft, the metering in of the additive takes place according to the invention in the clear center of the shaft. In order to ensure uniform distribution of the additive in the longitudinal direction, according to the invention the metering-in point of the additive in the process space may be moved along the longitudinal axis of the shaft, or the shaft is moved analogously or a number of feeding points of the additive are provided along the longitudinal axis of the shaft.

Other methods of destroying the bubbles by introducing mechanical energy at the phase boundary of the substrate are likewise conceivable according to the invention. For example, sound waves or else electromagnetic waves may increase the mass transfer by improving the migration of bubbles in the substrate. According to the invention, however, they also contribute to an improvement by the destruction of the bubbles at the phase boundary.

A further possibility for which protection is also separately sought, although with preference in conjunction with the first possibility, provides that a volatile or partly volatile (vaporizable) additive is incorporated in the substrate and bubbles of the vaporizable component that are produced in the substrate are destroyed. In this case, the rate at which the additive is added is to be at least 0.1 kg/h per kg of viscous mass per hour.

With preference, the additive is incorporated in the substrate by drop formation. In this case, the additive swells in the high-viscosity mass, for example because it vaporizes, and thereby creates surface area within the viscous mass. It has been found that the pressure within the bubbles thus produced reaches a pressure of greater than 1 bar (abs).

The volatile substance diffuses via the surface of the additive into the swollen additive. Then, in particular as a result of being subjected to mechanical action, the bubbles produced, with the additive and the volatile substance, reach the surface of the substrate. There, as described as preferred in relation to the first exemplary embodiment, the bubbles are then destroyed at the surface of the substrate, so that gas phases contained go over into the gas space.

The additive lowers the partial pressure in the gas phase around the substrate, so that a concentration gradient between the volatile substance and the additive of greater than 1:10 is produced.

The volatile substance and the additive leave the gas space together and are then treated separately, for example condensed and separated.

The entire process may take place under a vacuum, under atmospheric pressure or under positive pressure. Water in any desired state of aggregation is used with preference as the additive.

Devices that are particularly suitable for carrying out the method are mixing keaders with one or more horizontally arranged shafts, which turn with any desired speed of rotation in the same or different directions and are fitted with mixing and/or kneading elements. Such mixing kneaders can be found for example in DE 10 2009 061 077 A1. However, the present invention is not in any way restricted to these mixing kneaders or to mixing kneaders at all. It may be used in all mixing apparatuses in which a gas space is formed.

In the present case, what matters most is the distribution of the additive. A uniform distribution of the additive over the entire substrate is preferred, for which reason corresponding devices, for example spray nozzles, are provided.

1-28. (canceled)

29. A method for thermal separation of a volatile substance from a less volatile substrate with a phase boundary in relation to a gas space that receives the volatile substance after vaporization and/or sublimation, comprising the steps of vaporizing the volatile substance in a mass of the substrate, transporting bubbles to the surface or phase boundary of the less volatile substrate, and supplying mechanical energy to the surface or phase boundary for effectively destroying the bubbles at the surface or phase boundary.

30. The method as claimed in claim 29, including incorporating a volatile additive in the substrate wherein bubbles produced from the vaporizable component in the substrate are destroyed.

31. The method as claimed in claim 30, including feeding the additive at a rate of at least 0.1 kg/h per kg of viscous mass per hour.

32. The method as claimed in claim 30, wherein, as a result of being subjected to mechanical action, the bubbles produced, with the additive and the volatile substance, reach the surface of the substrate.

33. The method as claimed in claim 31, wherein the additive has a boiling point which lies between 10 K and 100 K below the temperature of the substrate.

34. The method as claimed in claim 30, wherein the volatile additive is applied to the phase boundary from the substrate to the gas space, which supplies mechanical energy to the phase boundary in the form of cavitation energy.

35. The method as claimed in claim 31, wherein the additive is water.

36. The method as claimed in claim 29, wherein the supply of mechanical energy takes place approximately uniformly over the entire phase boundary from the substrate to the gas space.

37. The method as claimed in claim 30, wherein the additive is metered onto a rotating shaft, on which the substrate is located, the rotation of the shaft providing a uniform distribution of the additive over a circumference of the rotation.

38. The method as claimed in claim 30, wherein the additive is metered onto the phase boundary within a rotating hollow body, on which the substrate is located, the rotation of the shaft providing the uniform distribution of the additive over a circumference of the rotation.

39. The method as claimed in claim 30, wherein the additive is added in one of a solid, a gaseous and liquid form.

40. The method as claimed in claim 30, wherein the additive is fed in under atmospheric pressure in the gas space.

41. The method as claimed in claim 29, including using sound waves to supply the mechanical energy to the phase boundary from the substrate to the gas space.

42. The method as claimed in claim 41, including directing a transmitter of the sound waves at the surface of a rotating shaft on which the substrate is located, the rotation of the shaft providing the uniform distribution of the sound waves over a circumference of the rotation.

43. The method as claimed in claim 41, including directing a transmitter of the sound waves at the surface within a rotating hollow body on which the substrate is located, the rotation of the shaft providing the uniform distribution of the sound waves over a circumference of the rotation.

44. The method as claimed in claim 29, including forming the substrate space and the gas space by a mixing kneader with at least one horizontally arranged shaft, on which kneading elements are located, the gas space and/or the substrate space being assigned devices for introducing at least one volatile or partly volatile additive.

45. The method as claimed in claim 44, wherein the devices are distributed uniformly over the gas space and/or the substrate space.

46. The method as claimed in claim 45, wherein the devices are spray nozzles.
